(19) United States
(12) Patent Application Publication
(10) Pub. No.: US 2020/0126036 A1
(43) Pub. Date: Apr. 23, 2020

(54) METHOD AND DEVICE FOR PROVIDING SHIPPING CONTAINER TRANSPORT SERVICES

(71) Applicants: Jin Yo Chou, Downers Grove, IL (US); Brian Story, Chicago, IL (US); Jieshun Pan, Oak Park, IL (US)

(72) Inventors: Jin Yo Chou, Downers Grove, IL (US); Brian Story, Chicago, IL (US); Jieshun Pan, Oak Park, IL (US)

(21) Appl. No.: 16/660,153

(22) Filed: Oct. 22, 2019

Related U.S. Application Data
(60) Provisional application No. 62/748,832, filed on Oct. 22, 2018.

(51) Int. Cl. G06Q 10/08; G06Q 10/04; G06Q 50/28

(52) U.S. Cl. CPC G06Q 10/0837; G06Q 10/08355; G06Q 10/08345; G06Q 50/28; G06Q 10/0838; G06Q 10/0833; G06Q 10/0831; G06Q 10/047

(57) ABSTRACT

A method for providing shipping container transport services is disclosed. The method allows the efficient and economic use, transport, and reuse and/or return of standard shipping containers. Users of the method include shipping service providers, shipping service users, and intermediaries whose resources and requirements are coordinated by a central system. Multiple factors including the transport requirements, location, time, cost, and urgency of shipping are tracked, compared, and evaluated to maximize usage and minimize non-usage storage and transport for the standard shipping containers. A device enabling the practice of the method is also disclosed.

### PRIORITY CLAIM

This application claims priority from one or more previously filed Provisional Patent applications, namely: METHOD AND DEVICE FOR PROVIDING SHIPPING CONTAINER TRANSPORT SERVICES, USPTO Ser. No. 62/748,832, filed Oct. 22, 2018.

This invention relates to a method for providing shipping container transport services. A large variety of variables about shipping container transport services users and providers are tracked and the data is used with a novel assignment method to provide shipping container transport services in an efficient and economic manner. Also disclosed is a device which can execute the method.

### BACKGROUND OF THE INVENTION

The present invention relates to a method for providing shipping services. Most modern logistical operations use standardized shipping containers of various sizes to transport goods. However, these shipping containers are expensive and must be re-used many times to justify their cost. Further, they are very heavy even when empty and must be transported by large truck or train, so returning them after the goods have been delivered and offloaded is expensive and time-consuming.

A method for providing shipping services which can efficiently and economically provide for the transport and use of shipping containers is a useful invention.

While modern shipping containers are generally of a limited number of standardized forms, they do vary in size and weight. Additionally, they require transport which is properly matched to the individual container's physical configuration. A method for providing shipping services which accounts for variation in individual shipping container configurations is a useful invention.

The movement of shipping containers while empty to return them to centralize depots for reuse is inefficient and uneconomical. A method for providing shipping services which maximizes the use of the shipping containers to transport goods and minimizes their transport while empty is a useful invention.

The movement of shipping containers requires drayage service providers to coordinate the availability of drivers and power units such as semi-trailer trucks compatible with a given shipping container with the need for drayage service of cargo owners, freight forwarders and freight brokers, and other potential uses. A method for providing quick and efficient tracking and coordination of such availability is a useful invention.

The present invention addresses these concerns.

### SUMMARY OF THE INVENTION

Among the many objectives of the present invention is the provision of a method for shipping container transport services.

Another objective of the present invention is to provide a method for planning and executing shipping services which can efficiently and economically transport and use shipping containers.

One more objective of the present invention is a method for effectively communicating the availability of drayage service providers to drayage service users.

A further objective of the present invention is a method for providing shipping services which maximizes the use of the shipping containers to transport goods and minimizes their transport while empty.

Yet another objective of the present invention is to provide a device for providing shipping container transport services.

Other objectives and advantages of the present invention will become apparent to those of ordinary skill in the art upon review of the disclosure herein.

### BRIEF DESCRIPTION OF THE DRAWINGS

FIG. 1 depicts a flow chart describing the first part of the method of the invention.

FIG. 2 depicts a flow chart describing the second part of the method of the invention.

FIG. 3 depicts a flow chart describing an alternate embodiment of the invention.

FIG. 4 depicts abstracted process diagrams for alternate processes in the art.

FIG. 5 shows an embodiment of the periodic inquiry to drayage providers regarding drayage availability.

FIG. 6 shows an embodiment of the Group Project Management improvement.

FIG. 7 shows an embodiment of the Network Linking improvement.

FIG. 8 shows an abstract flow diagram for the Trade-To-Match improvement.

FIG. 9 shows an abstract schematic for a computing device incorporating the invention.

FIG. 10 shows an embodiment of the Preferred Cost Parameters improvement.

FIG. 11 shows an embodiment of the Preferred Cost Parameters improvement.

FIG. 12 shows an embodiment of the Default Buy Box improvement.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

For purposes of this invention, the method can be performed either manually by human beings, as a series of instructions coded into computer software, or a mixture of both. The teachings of the invention enable those of ordinary skill in the art to convert the steps of the method to instructions coded into computer software: a computer or other electronic device storing and executing such instructions is an embodiment of the invention.

As used herein, the following definitions shall apply:
1) A Drayage Provider is a person or entity which provides drayage, the service of moving cargo containers for hire. Drayage providers own, lease or contract power units, which is a general term describing equipment for moving shipping containers overland by road.
2) Bulk Carriers are entities which own, lease or contract oceangoing motor vessels and/or railroads, suitable for transporting large numbers of shipping containers. It should be noted that in the shipping container logistics industry, most shipping containers are owned by bulk carriers, which lease or contract them to persons or entities such as cargo owners. The price of transporting goods can include the usage of a shipping container, or the two services (shipping container use and shipping container transport) can be charged separately. Bulk Carriers do not typically own or operate power units except to move shipping containers within or between their own shipping depots.
3) Shipping Service Providers (“SSP”) refers collectively to drayage providers and bulk carriers (when they transport shipping containers filled with goods belonging to another person or entity.)
4) Cargo Owners are manufacturers, distributors, or other entities which have goods to be shipped in a shipping container. Cargo owners which ship large quantities of goods over road or by sea sometimes own their own shipping containers, but otherwise use shipping containers provided by bulk carriers.
5) Freight Forwarders are persons or entities which offer logistical coordination services linking drayage providers, bulk carriers, and cargo owners.
6) Freight Brokers are persons or entities which offer logistical coordination services linking drayage providers, freight forwarders, and cargo owners.
7) Shipping Service Users (“SSU,”) also referred to as Shipping Service Receivers, refers collectively to bulk carriers (when they need drayage providers to transport their shipping containers from or back to a depot) cargo owners, freight forwarders and freight brokers.

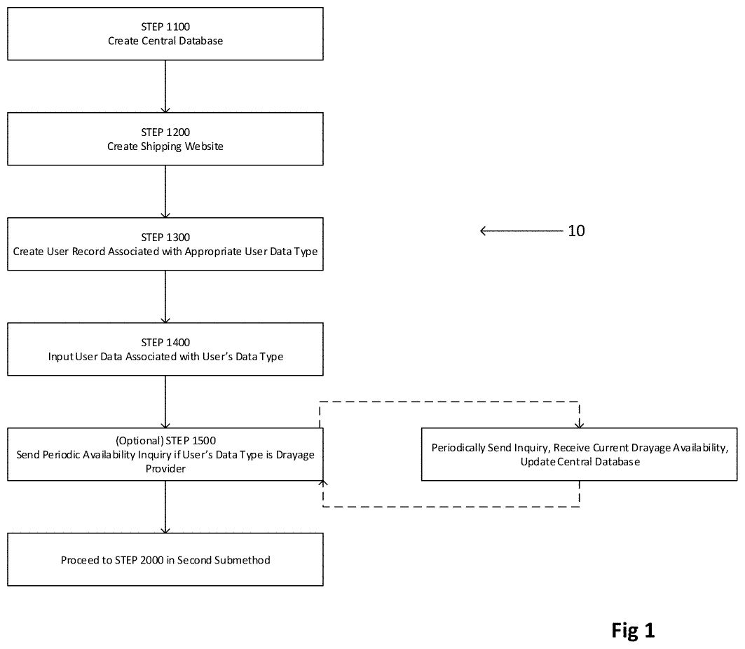

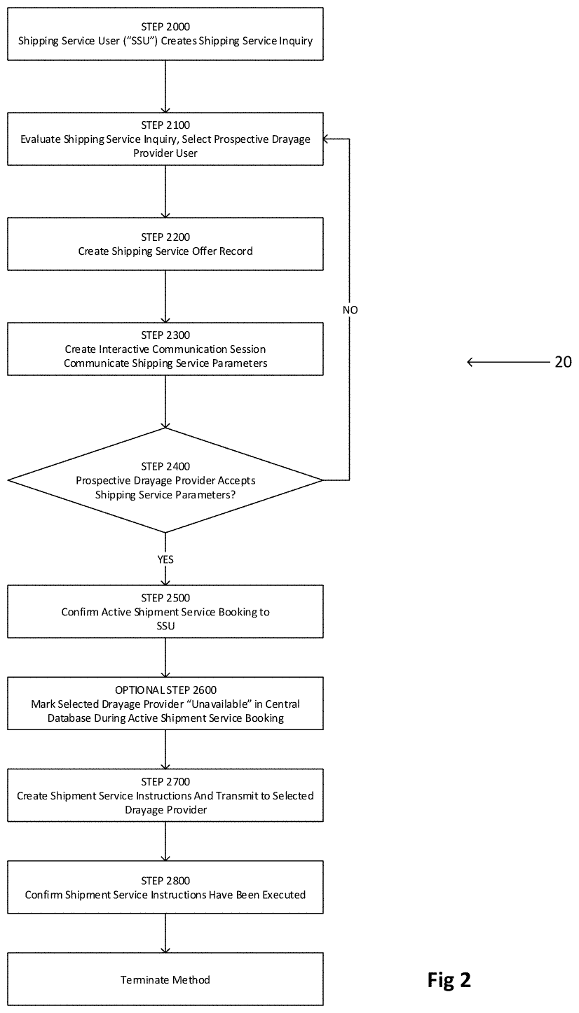

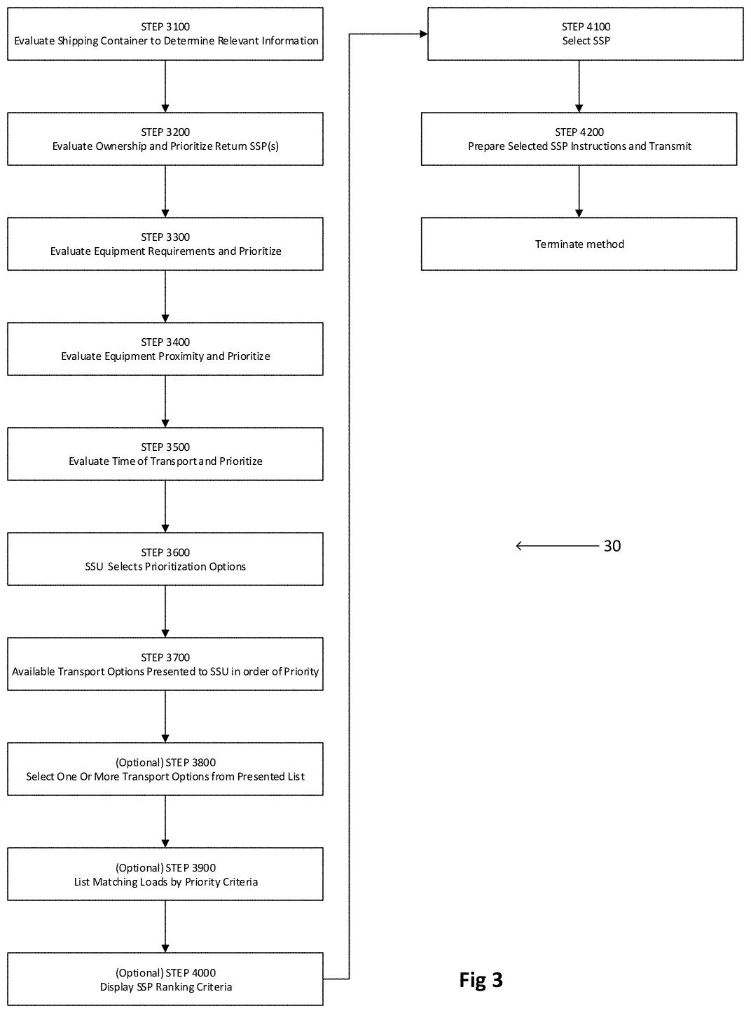

By referring to FIGS. 1 and 2, the preferred embodiment of the method for providing shipping services can be easily understood. FIG. 1 shows the first portion of the method, which involves gathering information regarding the various components of the shipping process. FIG. 2 shows the second portion of the method, which involves evaluating information regarding a particular shipment to be shipped using the method. It should be noted that the first portion of the method is itself a novel method for collecting information prior to the shipping service planning. Further, the second portion of the method is itself a novel method for providing shipping services and can be used independently of the first portion of the method. (See FIG. 3.) FIG. 1 shows first submethod 10, and FIG. 2 shows second submethod 20. First submethod 10 and second submethod 20 combine to form the method of the invention.

In STEP 1100, a central database able to contain information about a variety of users and providers of shipping container transport services is created. The central database comprises a plurality of specific user records, each associated with a user and containing a subset of specific user data fields which contain information about the user. It is required that each user be associated with one and only one of a plurality of user types, and that one of the subset of specific user data fields contain information about that user's user type.

It is required that there be a plurality of specific user data fields and that each specific user data field contain only the subset of user data fields associated with that user type. It is required that there be at least two user types, including a drayage provider user type and a shipping service receiver user type. It is preferred that the shipping service receiver user type be further specified as a freight forwarder user type, a freight broker user type, a cargo owner user type, and a bulk carrier user type. The specified user types are associated with the users defined above.

In STEP 1200, a shipping website which allows users to access the central database is created. For purposes of this application, “shipping website” includes any computer program, interface, or analogous application which allows users to access and process information in the central database as set forth herein. It is preferred, but not required, that the shipping website comprise an interface accessible from a user's computer or other device which uses a standard web browser application. Together, the central database and the shipping website comprise a shipping container transport service access system.

STEPS 1100 and 1200 need only be performed once for any given group of users: once they have been performed, all further steps including steps which are repeated assume that the central database exists and the shipping website has been created.

In STEP 1300, a (new) user accesses the central database via the shipping website and creates a user record associated with the user data type applicable to the user. Because each user data type is associated with unique user data (e.g. drayage providers will have user data that specifies the kind of power unit(s) they have and their availability for transporting shipping containers over land at any given time) it is required that each user record contain the subset of user data fields associated with the user's user type. It is strongly preferred, but not required, not to include user data fields which are not associated with the user's data type in that user's user record.

In STEP 1400, the user inputs the user data associated with the user data fields associated with the user's data type into the central database via the shipping website. For a drayage provider, this would include the various sizes and types of shipping containers the drayage provider has the appropriate power unit(s) to transport, the type and amount of insurance the drayage provider carries, certifications of the drayage provider's drivers, et cetera. The method then goes to Optional STEP 1500, or, if Optional STEP 1500 is not performed, to the first step in second submethod 20, STEP 2000 (see FIG. 2.)

STEPS 1300 and 1400 need only be performed once for any given user: once they have been performed, all further steps including steps which are repeated assume that the user has a user data record which has been populated with the user's data.

In Optional STEP 1500, a periodic inquiry is sent to the user if the user is a drayage provider. The periodic inquiry allows the drayage provider to specify the current availability of drayage to other users. This step repeats periodically at reasonable intervals. It is preferred that it be repeated not less than monthly and that the current availability be specified for at least one week at a time.

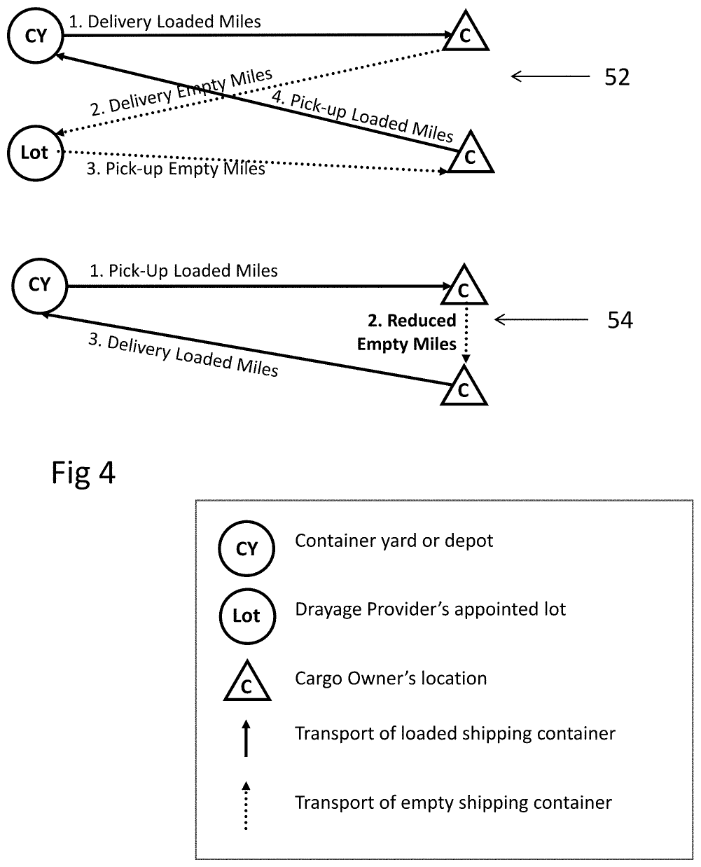

If Optional STEP 1500 is performed, it is required that the periodic inquiry be an active communication to drayage providers which allows them to easily and specifically communicate their currently available drayage capability. It is strongly preferred that the period inquiry take the form of an email to the drayage provider which allows them to indicate current available drayage capability by clicking on one or more active input areas in the body of the email. (See FIG. 4.) This action continues so long as the shipping container transport service access system is in use or until stopped by the user or the operator of the shipping container transport service access system.

FIG. 2 shows the steps of the method of the invention after data regarding the various users of the shipping container transport services has been entered in STEPS 1100-1500, collectively second submethod 20. Note that if such data is already available from a commercial database, another application, or any other reasonable means, such available data can be used with the following steps, which comprise a useful and novel method for providing shipping container transport services in and of themselves.

In STEP 2000, a shipping service user type user accesses the shipping website and creates a shipping service inquiry. The SSU can have an existing associated user record such as would be created in first submethod 10, or can create one during the creation of the shipping service inquiry which would require STEPS 1300 and 1400 to be performed by or for the SSU. The shipping service inquiry comprises a plurality of shipping service parameters including but not limited to date(s) of shipment, shipping container type and/or transport power unit(s) requirements, insurance requirements, certification requirements, pickup and/or dropoff point, et cetera.

It should be noted that the method is suitable for use for importing goods, for exporting goods, or for transporting goods between two points in a single country. If the shipping service users located in a first country wants to ship goods from the first country to a second country, it is an export shipping request. If the shipping service users located in a first country wants to ship goods from a second country to the first country, it is an import shipping request. An Import shipping request is typically related to a delivery move of container drayage and hauling the empty container empty back to the requested depot. An Export shipping request is typically related to a pickup move of container drayage after pulling an empty container from the depot.

It should also be noted that shipping containers are expensive pieces of capital equipment, which are typically owned by bulk carriers. Cargo owners, either of their own accord or through freight forwarders and/or freight brokers, are primarily concerned with having empty shipping containers delivered to be filled with goods to be shipped, and/or having filled shipping containers delivered to purchasers via the services of drayage providers, possibly in association with the services of freight forwarders, freight brokers, or bulk carriers. The shipping service parameters will include the requirements related to an empty shipping container to be filled with goods, a filled shipping container which is to be delivered, and/or an emptied shipping container which needs to be returned to a bulk carrier or other owner. (Also, see the description of the third optional improvement to the invention, infra.)

It is optional to allow the SSU to prioritize the evaluation of the shipping service inquiry according to specific parameters. For instance, the evaluation could be prioritized by selecting the drayage provider with the lowest rate to perform the desired shipping service, or by the shortest estimated time to complete the shipping service, or the closest available power unit(s) which satisfy the requirement(s) of the shipping container to be shipped, or by a prioritized combination of multiple such parameters. (See also the first alternate embodiment and the second optional improvement infra.)

In STEP 2100, the shipping website evaluates the shipping service inquiry to select a prospective drayage provider user whose user data indicates compatibility with the shipping service parameters, including their current drayage capability availability.

In STEP 2200, the shipping website creates a shipping service offer record which comprises all of the plurality of shipping service parameters in the central database. This can be an actual separate record or a “pointer,” temporary list, or other means of keeping track of the shipping service parameters which allows the shipping container transport service access system to communicate and record the shipping service parameters in later steps.

In STEP 2300, the shipping website creates an interactive communication session between the SSU and the prospective drayage provider. It is required that the shipping website provide the shipping service parameters to the prospective drayage provider as part of the interactive communication session, though they can be provided outside the interactive portion of the interactive communication session (e.g. provided in an email, the email providing a clickable link which will allow access to the interactive communication session.)

Any reasonable means of providing interactive communication can be used. It is required that the interactive communication session be updated in real time or with a very short delay (on the order of a few minutes.) Usable interactive communication means include, but are not limited to, electronic “chat” sessions, instant messages on either proprietary or general messaging systems, or cumulative posting sessions where one user can post a message in reply to the other user's posting a message and create a “threaded” or chronological series of posted messages.

In STEP 2400 the prospective drayage provider can accept or reject the shipping service parameters incorporated into the shipping service offer record via the interactive communication session. It is strongly preferred, but not required, that the prospective drayage provider be able to negotiate reasonable adjustments to the shipping service parameters, which if accepted by the SSU become part of the shipping service offer record.

If the prospective drayage provider accepts the shipping service offer record, it becomes an active shipment service booking in the central database, the prospective drayage provider is designated the selected drayage provider for the active shipment service booking, and the method continues. If the prospective drayage provider does not accept the shipping service offer record, the interactive communication session terminates and the method returns to STEP 2100 so the SSU can select an alternate prospective drayage provider.

In STEP 2500 the active shipment service booking is confirmed to the SSU. This can be done via the interactive communication session, via an email or other static message, or both.

In optional STEP 2600 the selected drayage provider can choose to be marked as “unavailable” for the duration of the active shipment service booking so that multiple shipments will not be booked to the same drayage provider. If a drayage provider has a plurality of power units such that it can ship more than one shipping container at a time, it is optional, but neither preferred nor required, that each power unit be tracked individually by the central database in association with that drayage provider's user record. If optional STEP 1500 is performed, it is optional, but neither preferred nor required, to send a periodic inquiry for each power unit associated with a drayage provider's user record and/or to allow drayage provider users to respond to periodic inquiries with availability information for multiple power units.

In STEP 2700 the shipping website creates a plurality of shipment service instructions which provide all reasonably necessary information required for the selected drayage provider to perform the active shipment service booking and transmits them to the selected drayage provider. These could include, but are not limited to, date and time of pickup, location of pickup, mandatory date and time of dropoff, address of pickup, address of dropoff, specific requirements and instructions such as the driver having a hazardous materials transport certification, et cetera. While it is required to perform this step, it is optional to do this at any reasonable point during the method of the invention. For instance, it can be done as part of and/or immediately after the creation of the shipping service offer record and/or before the creation of the interactive communication session.

In STEP 2800, the selected drayage provider confirms that the shipment service instructions have been executed via the shipping website, and the method terminates.

After the method terminates, Optional STEP 1500 may be repeated as appropriate. If the user, or another user, wishes to arrange for the transport of a shipping container, they begin to execute the method starting with STEP 2000.

It is optional to add additional steps or substeps such as payment confirmation, escrow, shipping manifest generation, customs documentation and shipping notices, appropriate shipping labels, as are reasonable and customary in the art.

FIG. 3 shows an alternate embodiment of the method, incorporating only the second part of the method and streamlining the operation of the method while describing in more detail the various shipping service parameters which could be used as part of the evaluation process.

By referring to FIG. 4 two possible methods of using a given shipping container for a delivery move and a pick-up move can be observed. The usage of a given shipping container for a delivery move and a pick-up move without returning the given shipping container to a shipping container depot first (also known commonly as “street turn” or “turn”) is a common industry practice. Due to the time it takes to move a shipping container into and out of a container depot, street turning a container can be more efficient than returning the empty shipping container to a depot after delivery, then picking it up from the depot for its next use. However, current practice of street turns, as shown in first shipping process 52, often involves leaving the shipping container at a drayage provider's lot or other shipping container holding location between the delivery move and pick-up move to wait for the right match allowing efficient utilization of the given shipping container. This is still an inefficient shipping process as the given shipping container is being hauled empty back to the drayage provider's lot and then hauled empty again to the pick-up location. These movements create significantly more transport of empty shipping containers throughout the execution of the delivery move and pick-up move than is necessary utilizing the method of the invention.

A more efficient shipping process minimizing the waste of resources (driver time, fuel use, shipping container availability, power unit usage . . . etc.) as taught by the method of the invention involves only three major movements of a shipping container in the same journey and is shown as second shipping process 54. First, a drayage provider hauls a shipping container for delivery from an original depot/terminal/port where it is available for use by a shipping service receiver. Second, the drayage provider moves the shipping container to a nearby cargo owner's location for loading of another shipment. Third, the drayage provider moves the loaded shipping container from the cargo owner's location to a requested depot/terminal/port. Though known in the art, it is a not common to use the three-step method of second shipping process 54 due to the complexity of matching the container owner, time, and location of two separate movements.

The novel methods and processes of this invention provide an innovative approach for matching loads which allow more containers to be moved in the more efficient manner described above. Method 20 can be used to book and execute either a delivery move or a pickup move. Method 30 can be used to book and execute alternative move for a similar journey. Although these two methods are mentioned separately and will be typically be described as two loads, the booking processes of the two methods often may happen at the same time to allow proper execution by the drayage provider on the same day or within short period of time.

Referring back to FIG. 3, method 30 comprises Steps 3100 through 4200. Each step comprises one or more substeps. It will be apparent to those of skill in the art that the order of the substeps may be altered in some cases without affecting the efficiency or novelty of the invention. Where it is required but not apparent that any step or substep must be performed in a certain order, it will be specified herein.

In STEP 3100, a shipping container which has already been booked for a delivery move (for example as in method 20) will be evaluated to determine the container owner, configuration, planned physical location(s), and desired specific destination along with any other relevant information—so an SSU needing an empty shipping container may search for a shipping container which is or will be in position. If there is a particular time frame within which the shipping container must reach the specific destination, this is also determined. Alternatively, if a pick-up move (instead of a delivery move) has been booked (for example as in method 20) then this load's information will be evaluated to determine the container owner, configuration, preferred physical location(s), and desired specific destination along with any other relevant information. All of these evaluations and determinations are made by a SSU and entered into a central database as in FIG. 1 or as otherwise appropriate.

Every shipping container has its own container number or other identifying information (hereafter “container number”) which may include electronic location monitoring services. The container number is used to identify the container in the system, but it is the owner, configuration, location and destination information which uniquely specifies the shipping container for purposes of the method. It is possible that multiple shipping containers could have similar or identical specification information: however, unless the power unit(s) are specified as being able to handle multiple containers (see STEP 3300) each such shipping container must be treated separately for purposes of the method.

In STEP 3200, after the information described in STEP 3100 is entered into the central database, the shipping website evaluates the shipping container's ownership and a priority of appropriate and available SSP based on ownership is assigned. The priority is set as one or more of the following, from most preferred to least preferred: the owner of the shipping container, a SSP which has a reciprocal return agreement with the owner of the shipping container, a SSP which offers the owner of the shipping container discounted rates, a SSP which has a standard return shipping agreement with the owner of the shipping container, and any other SSP which will do business with the owner of the shipping container.

Note that if a shipping container must be moved over water and then outside a steamship line's cargo depot, two SSP, including a drayage provider and a steamship line, will be required to complete the transport operation. For purposes of this application, it is required that at least one SSP which is a drayage provider must be selected. The following steps describe only that part of the method related to SSP which are drayage providers.

In STEP 3300 the power units which are available to transport the shipping container are evaluated and a priority of power unit(s) based on the requirements associated with the shipping container's physical configuration is assigned. The priority is set as one or more of the following: power unit(s) which meets the minimum necessary parameters (weight, length, height) to transport the shipping container, and power unit(s) which exceed the minimum necessary parameters to transport the shipping container. Any other requirements, such as hazmat certifications, state permits, or driver qualifications, are also specified in this step. The amount of time the driver has to lawfully operate a power unit before a break is required can also be included and evaluated.

In STEP 3400 the proximity of available power unit(s) to transport the shipping container is evaluated and a second priority of power unit(s) based on the proximity of suitable power unit(s) is assigned.

In STEP 3500 the time of transport for the shipping container is evaluated and a third priority based on required speed of transport is assigned. This can include options such as “fastest possible transport,” “transport time not specified,” or “arrival within (a fixed number of) hours.” If it is preferred to set the route not by time but by total distance traveled, which may be important with certain kinds of loads or to calculate carbon credits, this may also be set as a priority evaluation during this step. This time of transport can be evaluated by estimation of driving distance, by analysis of past travel over the same route by similar carriers, or by any other desired means.

In STEP 3600 the SSU selects one or more prioritization options for the available transport options which satisfy all the requirements evaluated in STEPS 3100-3500. These can include prioritizing power unit(s) proximity over total time in transit (which may be useful for the calculation of carbon credits or other accounting requirements) and/or prioritizing shortest return route over shortest return time (ditto) and/or any other reasonable and appropriate parameters the user wishes to set as a priority.

In STEP 3700 a list of available transport options to return the shipping container to the specific destination is shown to the user, compiled based upon the evaluations and prioritizations performed in STEPS 3100-3600. In optional STEP 3800 the user selects one or more transport options for further evaluation. It is optional to display an estimate or quotation for the shipping fees to return the container to the specific destination. If the user does not select specific transport options, all matching return shipment transport options continue to be evaluated by the method. If the user does select specific transport options, only those transport options are evaluated by the method in subsequent steps.

In optional STEP 3900 a list of matching loads which can be shipped in the shipping container during the return shipping process is displayed. These loads are ranked by one or more of the following criteria: extra travel time required to pick up and drop off, rate of pay for the load, and shipping timeframe requirements.

If SSP ranking information is not to be part of the final evaluation process, the method continues to STEP 4100. Otherwise the method continues to optional STEP 4000.

In optional STEP 4000 a ranking system based upon past performance with all of the SSP under evaluation displays SSP ranking information.

An optional improvement to STEP 4000 is to assign SSP indicators based on overall performance within the system, such as an indicator which indicates to SSU that the SSP has handled a given number of loads in the system, that they have handled a given number of hazardous materials loads in the system, that they have been an active user within the system for a given amount of time, and so on. These indicators can be textual (e.g. “1,000 Loads Transported” could appear in proximity to the SSP's name or identifying information,”) graphic (e.g. a badge or icon of a particular sort could appear, denoting that SSP as having shipped 1,000 loads) or both.

In STEP 4100 the user selects a selected SSP based upon the information displayed in STEPS 3700, 3800, and (if performed) STEP 3900 and 4000 and specifies any return loads which are to be picked up and transported by the selected SSP during the return process if displayed and selected by the user.

In STEP 4200 the return shipping order is compiled into a series of return shipment instructions to the selected SSP and transmitted to the selected SSP so that the return process may begin. Upon receipt of the return shipment instructions by the selected SSP, the selected SSP begins to comply with the return shipment instructions by dispatching the proper power unit(s) as directed in the return shipment instructions and the method terminates.

After the method terminates, if the user, or another user, wishes to arrange for the transport of a shipping container, they begin to execute the method starting with STEP 3100.

It is optional to add additional steps or substeps such as payment confirmation, escrow, shipping manifest generation, customs documentation and shipping notices, appropriate shipping labels, as are reasonable and customary in the art.

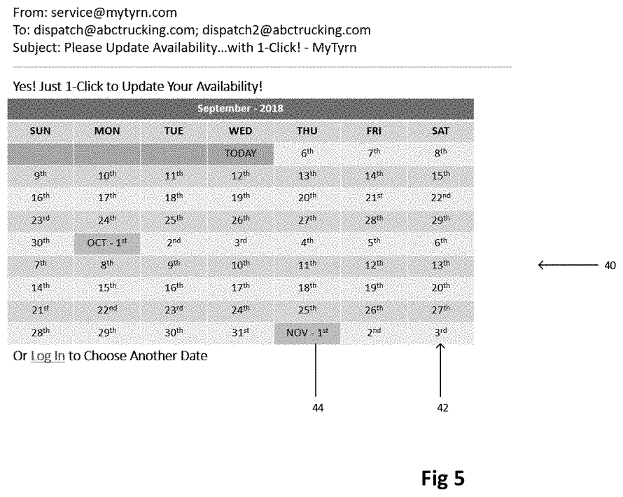

FIG. 5 shows the preferred embodiment of the periodic inquiry for drayage providers to provide drayage availability information. Email 40 includes availability matrix 42 which has multiple dates set forth as individual active input areas, one for each availability period such as a single calendar day. Drayage providers receive email 40 and click on the availability period(s) for which they have drayage available to transport shipping containers. When drayage providers click on individual active input areas it is optional to visually indicate that they have been marked as a drayage availability date as in highlighted date 44. Email 40 includes code which allows information regarding which availability period(s) the drayage provider has indicated they have drayage available to be sent back to the central database and stored in the user record associated with that drayage provider. If the drayage provider does not click any availability periods, no availability information is stored in the central database.

It is preferred, but not required, that drayage providers also be able to designate their availability periods directly in the system itself as opposed to by designating them through email links.

A first optional improvement to the invention (not shown) provides for the shipping container transport service access system to be operated by a service provider, and the service provider selling credits of some kind (“tokens,” etc) to drayage providers. Each time an interactive communication session is opened, the prospective drayage provider is charged one or more credit(s.) It is strongly preferred that if the prospective drayage provider does not accept the shipping service parameters, the credit(s) be returned.

A second optional improvement to the invention (not shown) provides for the central database to accept reviews and/or rankings of drayage provider type users from non-drayage provider type users, and the shipping website to display those reviews and/or rankings to non-drayage provider type users before opening the interactive communication session. If the non-drayage provider type user does not find the prospective drayage provider acceptable based on the reviews and/or rankings, an alternate prospective drayage provider can be selected and its information displayed to the non-drayage provider user. This can be combined with the first optional improvement. If reviews and/or rankings are accepted by the central database, the presence and relative evaluation levels of such reviews and/or rankings can be used as a shipping service parameter (see FIGS. 2 and 3.)

A third optional improvement to the invention (not shown) provides for the shipping container transport service access system to coordinate inquiries from a first non-drayage provider user for drayage providers regarding the delivery and/or return of empty shipping containers with requests from a second non-drayage provider user to transport goods in a shipping container. For example, if a full shipping container is going from City A to City B and will there be emptied of goods belonging to a first cargo owner, and a second cargo owner has goods in City B that need to go to City A and requires an empty shipping container to transport them in, the system could coordinate the request to transport the filled container to City B and the request to transport goods to City A such that the container, after being emptied in City B, is filled with the second cargo owner's goods before being returned to City A. This can be combined with the first and/or second optional improvements.

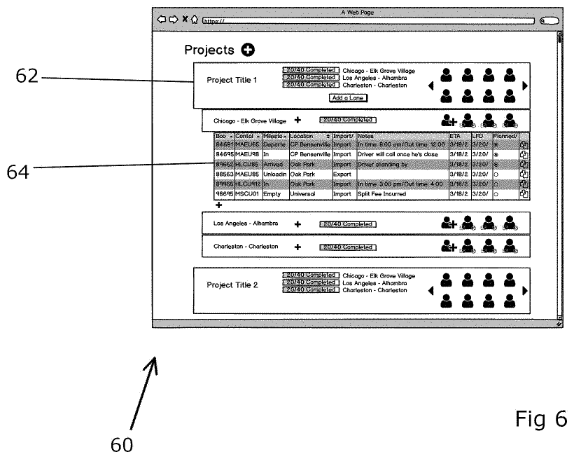

FIG. 6 shows a fourth optional improvement to the invention, the Project Group Management feature. Project management screen 60 shows a group of multiple loads to be shipped by the same SSU. This allows the coordination of multiple loads related to a single project so that they can conveniently be tracked as a group. For instance, a project may involve two loads of raw materials to be delivered, both starting out in the same or different places, one of which must go to an intermediate processing plant before going to a common destination and the other of which can go directly to the common destination. Once the raw material and processed raw material both reach the common destination, they may need to be combined to a final cargo and picked up by another drayage move to be shipped to a final destination. With this feature, SSU can easily group the loads that may be seem unrelated but should be managed together as a project. In addition to grouping unrelated shipments, SSU may also use the feature to quickly book a similar shipment. Another example is if an SSU needs to arrange many loads in a project, the SSU may use this feature to group the loads in the same lanes and see all the SSP they are already working with for each lane, make bookings to these SSP, and potentially invite more SSP in to the project and manage all the loads related to the same project in one place.

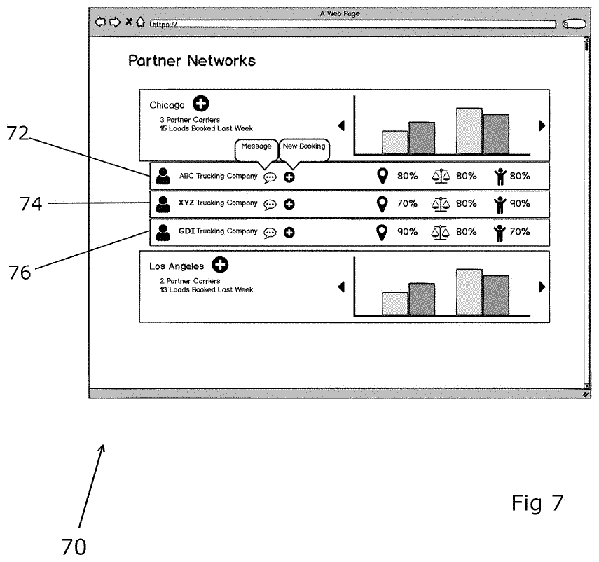

FIG. 7 shows a fifth optional improvement to the invention, the Network Linking feature. Network Linking screen 70 shows the network linking page for a single SSU. The SSU has network linked to first SSP 72, second SSP 74, and third SSP 76. As network links, these SSP are conveniently linked to the SSU's page. If the page is private, it provides a convenient list of linked SSP for the SSU's referral and can show current status and availability of those SSP. It can even, in combination with the optional SSP indicators in STEP 4000, show any new indicators earned by or assigned to the network linked SSP.

If the network linking page is visible to other SSU, those SSU who are familiar with the first SSU (the SSU whose network links are shown on network linking screen 70) can use the fact that the first SSU has network linked to those SSP as an indication of the level of service provided by those SSP.

The Network Linking feature can also be used in the other direction: SSP can form a Network Link with one or more SSU, providing convenient lists of SSU for referral and can show current status and load requests from those SSU. Similarly, if indicators such as described in STEP 4000 can also be assigned to SSU, the SSP can view any new indicators there.

Likewise, if a SSP's network linking page is visible to other SSP, those SSP who are familiar with the first SSP (the SSP whose network links are shown on the network linking page) can use the fact that the first SSP has network linked to those SSU as an indication of the trustworthiness of by those SSU in dealing with the first SSP.

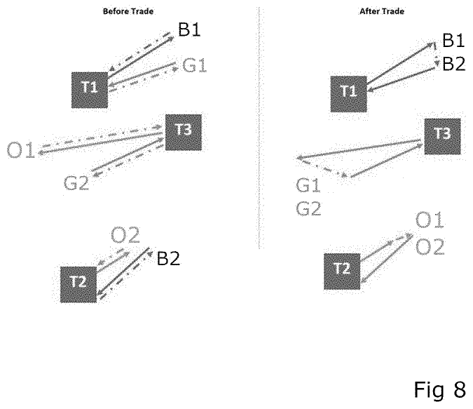

FIG. 8 shows a sixth optional improvement to the invention, the Trade-To-Match feature. Each of the units with a “T” designation represents a single terminal location where SSPs will be picking up from and delivering containers to bulk carriers. Each point designated with a B, a G, or an O is a destination: each destination has two loads associated with it. Each color represents an SSP (in this example we will identify each of them as SSP-“Color”). Each solid line represents a load. Each dash line next to the solid line represents the empty distance the SSP will need to drive in order to service the load. At the beginning of the operation, the loads have been assigned as follows:
1) SSP-Orange has to move load O1 (delivery/import) and load O2 (delivery/import);
2) SSP-Green has to move load G1 (pickup/export) and load G2 (pickup/export); and,
3) SSP-Blue has to move load B1 (delivery/import) and load B2 (pickup/export).

Each SSP has two loads. These loads are represented as solid lines for a load delivery and dashed lines for empty container movement. As an example, SSP-Blue has to take a load from T1 to B1 and return to T1. On a separate load, SSP-Blue has to take an empty container from T2 to B2 to be loaded, then return the full container to T2. SSP-Orange and SSP-Green also has two unrelated loads booked with them which they must service separately.

It should be noted that it is not necessary for each SSP to have loads moving in opposite directions for the method of the invention to benefit from this improvement. This improvement will be usable as long as the system can identify one of the loads as a better move for another SSP. Most shipping container loads are moved subject to a model contract known as the Uniform Intermodal Interchange and Facilities Access Agreement or UIIA (The UIIA is administered by a trade group known as the Intermodal Association of North America, or IANA. SEE: https://www.uiia.org/). Under the UIIA each SSP is responsible for returning the container it picks up from the terminal. Therefore, it often makes sense for the SSP to return the container at the end of its journey. However, the SSP may also decide to return a different container first for logistical reasons.

As is apparent, the load assignments are extremely inefficient. Every SSP has two empty container turns and must visit two separate terminals. At this point, the Trade-To-Match feature can be applied. The system allows SSP to form trusted groups, at one or more levels from individual truckers to drayage providers to general SSP. Here, all the SSP involved are individual truckers who have designated the SSP as trusted individuals, forming a Trade-To-Match group.

Before beginning their turns, the SSP all check in and see if there are Turn-To-Match assignments available. The system indicates that SSP-Blue can trade its B2 for G1. SSP-Orange can trade its O1 for B2. SSP-Green can trade its G1 for O1. Each SSP is now able to connect the two loads they are servicing into a single journey. For maximum efficiency, the empty container from the delivery load can be used to hold the pickup load. However, the SSP may decide to relay with another container for other logistics reasons. At the end of each turn the net number of containers at each destination has not changed, balancing the logistics while minimizing the effort required to service all the loads involved.

Although the example shows a three-way trade, this improvement allows any group of two or more SSP to trade assignments if they can provide efficiency improvements to each other. To maximize the possibility to create these trade opportunities and incentivize all SSP involved to agree to trading, it is optional, but not required, that limits on the number of SSP involved for each proposed trade can be set in advance.

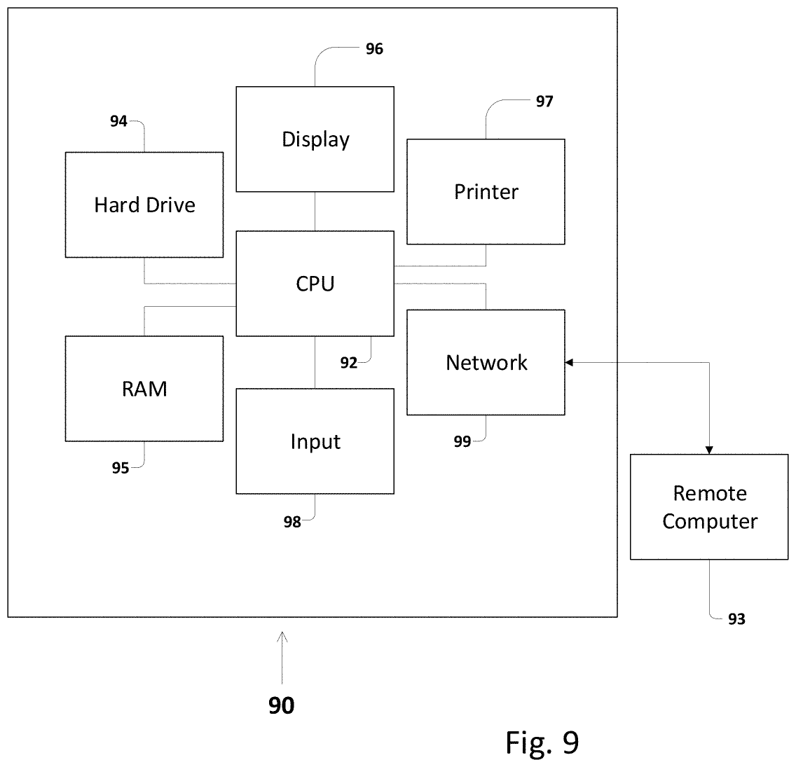

FIG. 9 shows an abstracted view of a general or special purpose computer or other electronic device which can execute the steps of the method and/or the alternate embodiment(s) of the method after converting them to computer code and storing the code for execution by the device. Computer 90 comprises CPU 92, Random Access Memory 95, and Hard Drive 94. Code embodying the steps of the method is stored on Hard Drive 94, loaded into RAM 95, and executed by CPU 92. Output from the method can be sent to Display 96 and/or Printer 97. Remote Computer 93 can be used by SSP, SSU, or both to access Computer 90 and send and receive information related to executing the method.

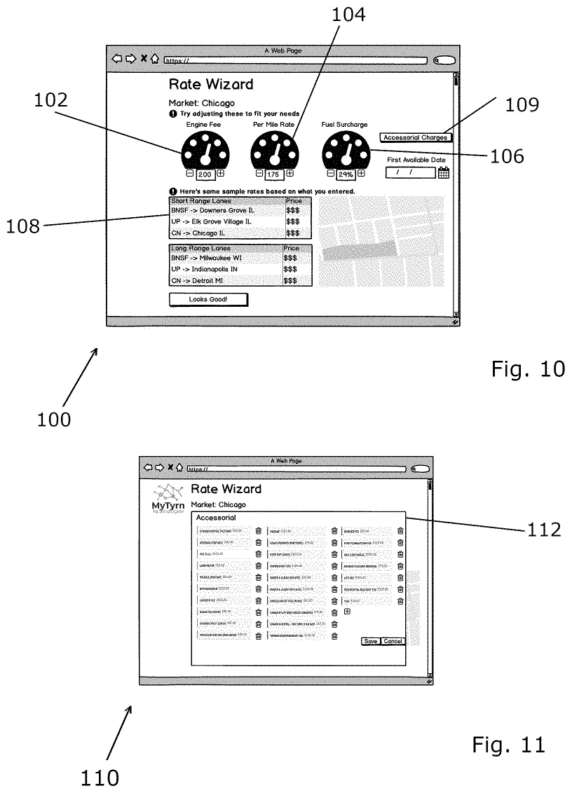

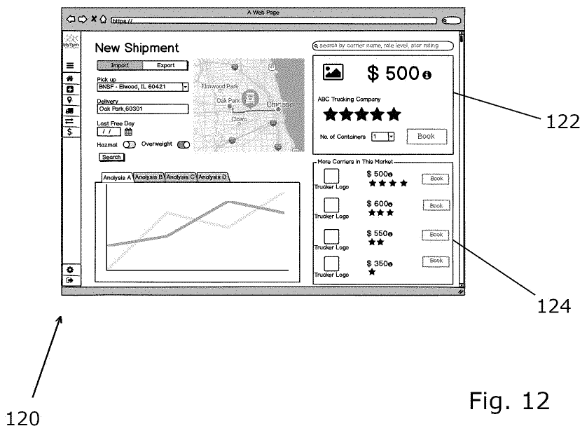

FIGS. 10 and 11 show a seventh optional improvement to the invention, the Preferred Cost Parameters interface. An SSU who is using the method of the invention can further break down their cost preferences and limits by entering limits and/or preferences regarding various components of the total cost of shipping a load. Here, Preferred Cost Parameter Screen 100 has Engine Fee Limiter 102, Per Mile Fee Limiter 104, and Fuel Surcharge Limiter 106. By adjusting these parameters, the available transport options are further limited to those which fit within them. These can be hard limits or preferences: if they are set as preferences, transport options which exceed them will still be shown, but the system will attempt to order them to get the closest fit possible to the set preferences. The available transport options fitting/closest to the set preferences are shown in output list 108. Optional Accessorial Settings Screen 110 (accessed by activating Accessorial Settings Control 109 on Preferred Cost Parameter Screen 100) allows the SSU to either set maximum limits for individual accessorial costs, or remove them altogether in Accessorial Cost Parameter List 112. Alternatively, this improvement can also be used for SSP to easily submit and update a portion of the information required in STEP 1400.

FIG. 12 shows an eighth optional improvement to the method of the invention, the Default Buy Box. Output Screen 120 shows the result of the search of STEP 3700. (See FIG. 3.) Default Buy Box 122 shows a “default” SSP which is suggested for use by the SSU user. It has a “Book” button which will automatically book the shipment to that SSP. The default SSP is chosen by selecting the SSP on the available transport list which has the best combination of activity level, customer service ratings, and shipping rate, according to an arbitrary algorithm selected by the administrator of the method. (And/Or separately expressed general preferences from that SSU.) The other potential SSP are shown in Output List Box 124. It is neither preferred nor required to show both a default SSP and alternative SSP on the same output list, page or screen. It is required that if this is not done, that the SSU has the option to see the alternative SSP if they do not wish to book the default SSP.

It will be obvious to those of ordinary skill in the art that Computer 90 could be an actual laptop or desktop computer, a client terminal accessing a server system, or a virtual machine running as an instance on one or more physical devices. Similarly Remote Computer 93 could likewise be a special purpose device, a laptop, desktop, smartphone or tablet, a client terminal accessing a server system, or a virtual machine running as an instance on one or more physical devices.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1) A method for providing shipping container transport services comprising the steps of:
a) Creating a shipping container transport service access system, the shipping container transport service access system comprising a central database and a shipping website, the central database being accessible by a plurality of users via the shipping website, each of the plurality of users associated with one of a plurality of specific user records in the central database;
b) Selecting a specific user type from a plurality of user types including at least a drayage provider user type and a shipping service user user type, the specific user type associated with a user, the user being one of the plurality of users;
c) Creating a user record associated with the user in a central database, the user record being one of the plurality of specific user records and comprising a specific subset of user data fields, the specific subset of user data fields selected from a plurality of user data fields, wherein the subset of user data fields are all of the plurality of user data fields associated with the specific user type;
d) Storing a plurality of user data values in the specific subset of user data fields, the plurality of user data values associated with the user;
e) Evaluating the specific user type and, if the specific user type is the drayage provider user type, designating the user as a drayage provider and periodically contacting the user to update the plurality of drayage user values with one or more current drayage provider user data values including one or more drayage availability values;
f) Accepting a shipping service inquiry from a second user via the shipping container transport service access system, the shipping service inquiry containing a plurality of shipping service parameters input via the shipping website, the second user being one of the plurality of users which is associated with the shipping service user user type;
g) Using the shipping service parameters to select a prospective drayage provider, the prospective drayage provider being one of the plurality of users in the central database which is associated with the drayage provider user type and which has drayage user values compatible with the shipping service parameters;
h) Creating a shipping service offer record in the central database, the shipping service offer record containing all of the plurality of shipping service parameters contained in the shipping service inquiry;
i) Creating an interactive communication session between the second user and the prospective drayage provider, including transmitting the shipping service offer record to the prospective drayage provider;
j) Allowing the prospective drayage provider to accept or reject the shipping service offer record through the interactive communication session, if the prospective drayage provider accepts the shipping service offer record designating the shipping service offer record as an active shipment service booking in the central database and designating the prospective drayage provider as a selected drayage provider, otherwise returning to the step of selecting the prospective drayage provider and selecting an alternate drayage provider;
k) Confirming the active shipment service booking to the second user;
l) Setting the availability value of the selected drayage provider to unavailable during the active shipment service booking;
m) Transmitting a plurality of shipment service instructions to the selected drayage provider, the plurality of shipment service instructions containing all information reasonably required to allow the selected drayage provider to perform the active shipment service booking; and,
n) Confirming that the selected drayage provider has executed the shipment service instructions.

2) A method for providing shipping container transport services comprising the steps of:
a) Selecting a standard shipping container which has been unloaded after delivering a first load of goods to return to an owner shipping company;
b) Evaluating the standard shipping container to determine the owner shipping company and/or one or more acceptable non-owner shipping companies to return the standard shipping container;
c) Evaluating the standard shipping container to determine one or more power unit(s) types which can return the standard shipping container to allow the selection of one or more suitable return shipment transports;
d) Evaluating the location of the standard shipping container to determine the proximity of the one or more return shipment transports which can return the standard shipping container;
e) Evaluating one or more suitable return shipment routes to determine a time of transport for each of the one or more suitable shipment routes and a distance of transport for each of the one or more suitable shipment routes;
f) Evaluating one or more suitable return loads which can be shipped in the standard shipping container and which are located in proximity to the one or more suitable shipment routes;
g) Displaying the owner shipment company and/or the acceptable non-owner shipment companies, the suitable return shipment transports, the suitable return shipment routes and the return loads to a user;
h) Allowing the user to select a selected shipping service provider from the owner shipping company and/or the non-owner shipping companies;
i) Allowing the user to select a return shipment transport from the suitable return shipment transports;
j) Allowing the user to select a return shipment route from the suitable return shipment routes;
k) Allowing the user to select zero, one, or more than one return loads from the suitable return loads;
l) Preparing a set of return shipment instructions detailing how the standard shipment container is to be returned to the owner shipping company with respect to the return shipment transport, the return shipment route, and the suitable return loads if any suitable return loads were selected; and,
m) Transmitting the return shipment instructions to the selected shipping service provider.

3) A method for providing shipping container transport services as in claim 1 wherein periodically contacting a group of drayage providers, the group of drayage service providers comprising one or more of the plurality of users which are associated with the drayage provider user type, to update the drayage user data values with one or more current drayage user data values is done by sending an email to the group of drayage providers, the email including a plurality of current availability value indicators, and wherein a respondent, the respondent being a human being responding to the email, can click directly on one or more of the plurality of current availability value indicators to update the drayage availability values.

4) A method for providing shipping container transport services as in claim 1 wherein drayage provider type users purchase a plurality of credits from a service provider, the service provider operating the shipping website and tracking the credits in a credit record associated with a specific drayage provider, and one or more of the plurality of credits is deducted from the credit record every time an interactive communication session is opened between the specific drayage provider and a shipping service user.

5) A method for providing shipping container transport services as in claim 1 wherein one or more shipping service user type users can enter a review and/or a rating for a drayage provider type user, and the review and/or rating is provided to the second user before and/or during the interactive communication session.

6) A method for providing shipping container transport services as in claim 2 wherein the step of displaying the owner shipment company and/or the acceptable non-owner shipment companies, the suitable return shipment transports, the suitable return shipment routes and the return loads to a user further comprises the step of:
n) Displaying, for each acceptable non-owner shipment company, one or more indicators to the user, each of the one or more indicators indicating at least one objective fact based on a historical performance of the acceptable non-owner shipment company.

7) A method for providing shipping container transport services as in claim 6 wherein the one or more indicators include an indicator for a defined number of loads shipped and/or an indicator for a defined length of time that the acceptable non-owner shipment company has been shipping loads.

8) A method for providing shipping container transport services as in claim 1 wherein the second user can select at least two shipping service offer records to form a shipping group record, the shipping group record being accessible by the second user so that the second user can view all of the shipping service offer records in the shipping group record as a group list.

9) A method for providing shipping container transport services as in claim 2 wherein the user can create more than one set of return shipment instructions, and wherein the user can select at least two sets of return shipment instructions to form a shipping group record, the shipping group record being accessible by the user so that the user can view all of the sets of return shipment instructions in the shipping group record as a group list.

10) A method for providing shipping container transport services as in claim 1 wherein a first one of the plurality of users can designate at least one of the plurality of users who are not the first one of the plurality of users as network linked users, and the first one of the plurality of users can view all of their network linked users as a list of network linked users.

11) A method for providing shipping container transport services as in claim 10 wherein at least one of the plurality of users who are not the first one of the plurality of users can view the list of network linked users.

12) A method for providing shipping container transport services as in claim 11 wherein the first one of the plurality of users can associate one or more comments and/or indicators with one or more of the network linked users, the comments and/or indicators visible to the at least one of the plurality of users who can view the list of network linked users.

13) A method for providing shipping container transport services as in claim 1 wherein before the step of confirming that the selected drayage provider has executed the shipment service instructions is performed, the following additional steps are performed:
o) Repeating steps (f) through (m) by a third user, such that the second user has issued a first set of shipment service instructions having a first plurality of shipment service elements to a first drayage provider, and the third user has issued a second set of shipment service instructions having a second plurality of shipment service elements to a second drayage provider respectively;
p) Designating a first unit of the first drayage provider to carry out the first set of shipment service instructions;
q) Designating a second unit of the second drayage provider to carry out the second set of shipment service instructions, the first set of shipment service instructions and the second set of shipment service instructions forming an overall set of shipment service instructions;
r) Adding the first unit and the second unit to a trade-to-match group, the trade-to-match group having a set of shipment turns, the set of shipment turns comprising a set of physical shipment movements corresponding to the overall set of shipment service instructions;
s) Reviewing the overall set of shipment service instructions to determine whether the set of shipment turns could be made more efficient by altering the overall set of shipment service instructions and if so proceeding to the next step, otherwise omitting the next two steps;
t) Altering the overall set of shipment service instructions to make the set of shipment turns more efficient to create at least one set of altered shipment service instructions; and
u) Transmitting the at least one set of altered shipment instructions to the first drayage provider and/or the first unit and/or the second drayage provider and/or the second unit.

14) A method for providing shipping container transport services as in claim 13 wherein one or more of the first drayage provider, the second drayage provider, and the third drayage provider are a single drayage provider.

15) A method for providing shipping container transport services as in claim 13 wherein one or more of the second user, the third user, and the fourth user are a single user.

16) A method for providing shipping container transport services as in claim 15 wherein one or more of the first drayage provider, the second drayage provider, and the third drayage provider are a single drayage provider.

17) A method for providing shipping container transport services comprising the steps of:
a) Assigning a first cargo turn and a second cargo turn to a first power unit operated by a first operator, the first cargo turn and the second cargo turn representing moving one of a plurality of shipping containers being moved to one of a plurality of destinations;
b) Assigning a third cargo turn and a fourth cargo turn to a second power unit operated by a second operator, the third cargo turn and the fourth cargo turn representing moving one of the plurality of shipping containers being moved to one of the plurality of destinations, the first cargo turn, the second cargo turn, the third cargo turn and the fourth cargo turn comprising a set of individual cargo turns;
c) Allowing the first operator and the second operator to join a trade-to-match group;
d) Evaluating the set of cargo turns to see if moving the plurality of shipping containers to the plurality of destinations can be made more efficient by reassigning the set of individual cargo turns to form a new set of individual cargo turns and if so, continuing the method, otherwise stopping the method;
e) Reassigning the set of individual cargo turns to form the new set of individual cargo turns; and,
f) Transmitting the new set of individual cargo turns to the trade-to-match group.

18) A method for providing shipping container transport services as in claim 17 wherein at least three power units corresponding to at least three operators are each assigned at least two cargo turns prior to Step (C), and the method then proceeds using the at least two cargo turns assigned to each of the at least three power units and allowing all of the at least three operators to join the trade-to-match group.

19) A device for providing shipping container transport services comprising:
a) a digital computer comprising a CPU, a RAM and/or a persistent storage device, an input device, and a visual display, the RAM and/or the persistent storage device, the input device, and the visual display operably connected to the CPU;
b) a shipping transport service application file stored on the persistent storage device, the shipping transport service application file comprising a set of instructions which are executed by the CPU and cause the shipping transport service application to perform the following operations;
i. Create a shipping container transport service application, the shipping container transport service application comprising a central database and a shipping website, the central database accessible by a plurality of users via the shipping website, each of the plurality of users associated with one of a plurality of specific user records in the central database;
ii. Select a specific user type from a plurality of user types including at least a drayage provider user type and a shipping service user user type, the specific user type associated with a user, the user being one of the plurality of users;
iii. Create a user record associated with the user in a central database, the user record being one of the plurality of specific user records and comprising a specific subset of user data fields, the specific subset of user data fields selected from a plurality of user data fields, wherein the subset of user data fields are all of the plurality of user data fields associated with the specific user type;
iv. Store a plurality of user data values in the specific subset of user data fields, the plurality of user data values associated with the user;
v. Evaluate the specific user type and, if the specific user type is the drayage provider user type, designate the user as a drayage provider and periodically contact the user to update the plurality of drayage user values with one or more current drayage provider user data values including one or more drayage availability values;
vi. Accept a shipping service inquiry from a second user via the shipping container transport service access system, the shipping service inquiry containing a plurality of shipping service parameters related to a shipment input via the shipping website, the second user being one of the plurality of users which is associated with the shipping service user user type;
vii. Use the shipping service parameters to select a prospective drayage provider, the prospective drayage provider being one of the plurality of users in the central database which is associated with the drayage provider user type and which has drayage user values compatible with the shipping service parameters;
viii. Create a shipping service offer record in the central database, the shipping service offer record containing all of the plurality of shipping service parameters contained in the shipping service inquiry;
ix. Implement an interactive communication session between the second user and the prospective drayage provider, including transmitting the shipping service offer record to the prospective drayage provider;
x. Allow the prospective drayage provider to accept or reject the shipping service offer record through the interactive communication session, if the prospective drayage provider accepts the shipping service offer record designate the shipping service offer record as an active shipment service booking in the central database and designate the prospective drayage provider as a selected drayage provider, otherwise return to the instruction allowing the second user to select the prospective drayage provider and selecting an alternate drayage provider;
xi. Confirm the active shipment service booking to the second user;
xii. Set the availability value of the selected drayage provider to unavailable during the active shipment service booking;
xiii. Transmit a plurality of shipment service instructions to the selected drayage provider, the plurality of shipment service instructions containing all information reasonably required to allow the selected drayage provider to perform the active shipment service booking;
and,
xiv. Confirm that the selected drayage provider has executed the shipment service instructions upon the shipment being delivered by the selected drayage provider.

20) A device for providing shipping container transport services comprising:
a) a digital computer comprising a CPU, a RAM and/or a persistent storage device, an input device, and a visual display, the RAM and/or the persistent storage device, the input device, and the visual display operably connected to the CPU;
b) a shipping transport service application file stored on the persistent storage device, the shipping transport service application file comprising a set of instructions which are executed by the CPU and cause the shipping transport service application to perform the following operations;
i. Identify a standard shipping container which has been unloaded after delivering a first load of goods to return to an owner shipping company based on a user input;
ii. Evaluate the standard shipping container to determine the owner shipping company and/or one or more acceptable non-owner shipping companies to return the standard shipping container;
iii. Evaluate the standard shipping container to determine one or more power unit(s) types which can return the standard shipping container to allow the selection of one or more suitable return shipment transports;
iv. Evaluate the location of the standard shipping container to determine the proximity of the one or more return shipment transports which can return the standard shipping container;
v. Evaluate one or more suitable return shipment routes to determine a time of transport for each of the one or more suitable shipment routes and a distance of transport for each of the one or more suitable shipment routes;
vi. Evaluate one or more suitable return loads which can be shipped in the standard shipping container and which are located in proximity to the one or more suitable shipment routes;
vii. Display the owner shipment company and/or the acceptable non-owner shipment companies, the suitable return shipment transports, the suitable return shipment routes and the return loads to a user;
viii. Allow the user to select a selected shipping service provider from the owner shipping company and/or the non-owner shipping companies;
ix. Allow the user to select a return shipment transport from the suitable return shipment transports;
x. Allow the user to select a return shipment route from the suitable return shipment routes;
xi. Allow the user to select zero, one, or more than one return loads from the suitable return loads;
xii. Allow a set of return shipment instructions detailing how the standard shipment container is to be returned to the owner shipping company with respect to the return shipment transport, the return shipment route, and the suitable return loads if any suitable return loads were selected; and,
xiii. Transmit the return shipment instructions to the selected shipping service provider.
